(19) United States
(12) Patent Application Publication
(10) Pub. No.: US 2003/0051568 A1
(43) Pub. Date: Mar. 20, 2003

(54) Transmission system for an electric carrier

(76) Inventor: Gordon Liao, Yung Kang City (TW)

Correspondence Address: PRO-TECHTOR INTERNATIONAL, 20775 Norada Court, Saratoga, CA, 95070-3018, US

(21) Appl. No.: 09/888,131

(22) Filed: Jun. 23, 2001

(51) Int. Cl. F16H 3/14

(52) U.S. Cl. 74/376

(57) ABSTRACT

A transmission system for an electric carrier includes a power source, a speed-reducing gear set, two parallel shafts rotated by the power source, two transmitting members fixed on the two shafts in a vertical condition. A one-way bearing is provided between each transmitting member and the shaft. And a carrier wheel is fixed on an output axle driven by the transmitting members. Clockwise and counterclockwise rotation of the power source with cooperation of the one-way bearings enables the transmitting course change the speed of the electric carrier, lowering the cost and saving energy.

### BACKGROUND OF THE INVENTION

This invention relates to a transmission system for an electric carrier, particularly to one possible to be manufactured with a low cost, easy to operate and possible to save energy.

A conventional transmission system for an electric carrier mostly uses a motor with a fixed speed-reducing gear ratio, to achieve the purpose of driving the wheels. Such speeds are directly controlled to be slow or fast by the rotation speed of the motor and control the running speed of wheels. This simple transmission system of an electric carrier, though having a low cost, cannot have any fun on riding, having sufficient motor output to have the effective drive, and match the up and down road condition, and resulting in the fast consumption of a battery. In other words, the kind of transmission system of a motor with a fixed speed-reducing ratio cannot offer two different required torques for climbing up a steep slope or riding with high speed. When using this transmission system on a flat ground, with a lower gear and a high speed, the electric carrier will not have enough torque to climb up a hill. Therefore, an automobile, a motorcycle, or an electric bike always is installed with a speed-changing system to meet various road conditions for saving energy.

In general, a DC motor has the characteristic of a low speed with a high torque, and a high speed with a low torque, but studying the efficiency curve of a motor, it will be found that neither a high speed nor a low speed is the best. The best efficiency scope is between 60% -85% with no load speed, so in order to save electricity, the motor speed has to be controlled in the best efficiency scope. A fixed speed-reducing transmission system is affected by an external environmental factor, with the motor rotation scope exceed the best efficiency scope too much, and does not perform as desired in saving electricity.

Therefore, the high end of an advanced electric carrier should have a speed-changing system, to improve the defects of the fixed speed-reducing transmission system, but such structure is complicated and accurate, requiring much higher cost, and this is the reason why a medium or low priced electric carriers widely use such a fixed speed reducing system. For example, the current electric bike cost much lower than a motorcycle, so the speed-changing system is much simpler than the latter. The speed-changing system of an electric bike uses a chain to drive a flywheel of various sizes to achieve the purpose of changing speed. But the size and the dimensions of such a speed-changing system is still too large for a lightweight electrical carrier such as an electrical skateboard, and its handling is not so convenient. When the riding speed changes from slow to fast, the speed-reducing ratio starts from the large one and changes to the small one. Once it is braked to stop, the chain still stays on the flywheel on the smallest speed-reducing ratio, requiring restart by man power, and such a transmission method will be not proper for an electric skateboard, an electric wheelchair, or an electric golf cart.

### SUMMARY OF THE INVENTION

The objective of the invention is to offer a transmission system for an electric carrier improved in the defects of the conventional transmission system for an electric carrier by utilizing four one-way bearings for coordination with clockwise or counterclockwise rotation of a motor, to switch the power transmitting route for various speed changing and merging power so as to lower the cost, to facilitate operation and to save energy.

### BRIEF DESCRIPTION OF DRAWINGS

This invention will be better understood by referring to the accompanying drawings, wherein:

FIG. 1 is an upper view of a first embodiment of a transmission system for an electric carrier in the present invention;

FIG. 2 is a front view of the first embodiment of a transmission system for an electric carrier in the present invention;

FIG. 3 is an upper view of a second embodiment of a transmission system for an electric carrier in the present invention;

FIG. 4 is a front view of the second embodiment of a transmission system for an electric carrier in the present invention;

FIG. 5 is an upper view of a third embodiment of a transmission system for an electric carrier in the present invention;

FIG. 6 is a cross-sectional view of the line A-A in FIG. 5;

FIG. 7 is a cross-sectional view of the line B-B in FIG. 5;

FIG. 8 is an upper view of a fourth embodiment of a transmission system for an electric carrier in the present invention;

FIG. 9 is a cross-sectional view of the line A-A in FIG. 8;

FIG. 10 is a cross-sectional view of the line B-B in FIG. 8;

FIG. 11 is an upper view of a fifth embodiment of a transmission system for an electric carrier in the present invention;

FIG. 12 is a front view of the fifth embodiment of a transmission system for an electric carrier in the present invention;

FIG. 13 is an upper view of a sixth embodiment of a transmission system for an electric carrier in the present invention;

FIG. 14 is a front view of the sixth embodiment of a transmission system for an electric carrier in the present invention;

FIG. 15 is an upper view of a seventh embodiment of a transmission system for an electric carrier in the present invention;

FIG. 16 is a front view of the seventh embodiment of a transmission system for an electric carrier in the present invention;

FIG. 17 is a cross-sectional view of the line A-A in FIG. 15;

FIG. 18 is an upper view of an eighth embodiment of a transmission system for an electric carrier in the present invention;

FIG. 19 is a front view of the eighth embodiment of a transmission system for an electric carrier in the preset invention;

FIG. 20 is a cross-sectional view of the line A-A in FIG. 18;

FIG. 21 is an upper view of a ninth embodiment of an transmission system for an electric carrier in the present invention;

FIG. 22 is a cross-sectional view of the line A-A in FIG. 21;

FIG. 23 is a cross-sectional view of the line B-B in FIG. 21;

FIG. 24 is an upper view of a tenth embodiment of a transmission system for an electric carrier in the present invention;

FIG. 25 is a cross-sectional view of the line A-A in FIG. 24;

FIG. 26 is a cross-sectional view of the line B-B in FIG. 24;

FIG. 27 a front view of an eleventh embodiment of a transmission system for an electric carrier in the present invention;

FIG. 28 is a front view of a twelfth embodiment of a transmission system for an electric carrier in the present invention;

FIG. 29 is a front view of a thirteenth embodiment of a transmission system for an electric carrier in the present invention;

FIG. 30 is a front view of a fourteenth embodiment of a transmission system for an electric carrier in the present invention;

FIG. 31 is a front view of a fifteenth embodiment of a transmission system for an electric carrier in the present invention;

FIG. 32 is a front view of a sixteenth embodiment of a transmission system for an electric carrier in the present invention.

### DETAILED DESCRIPTION OF THE PREFERRED EMBODIMENTS

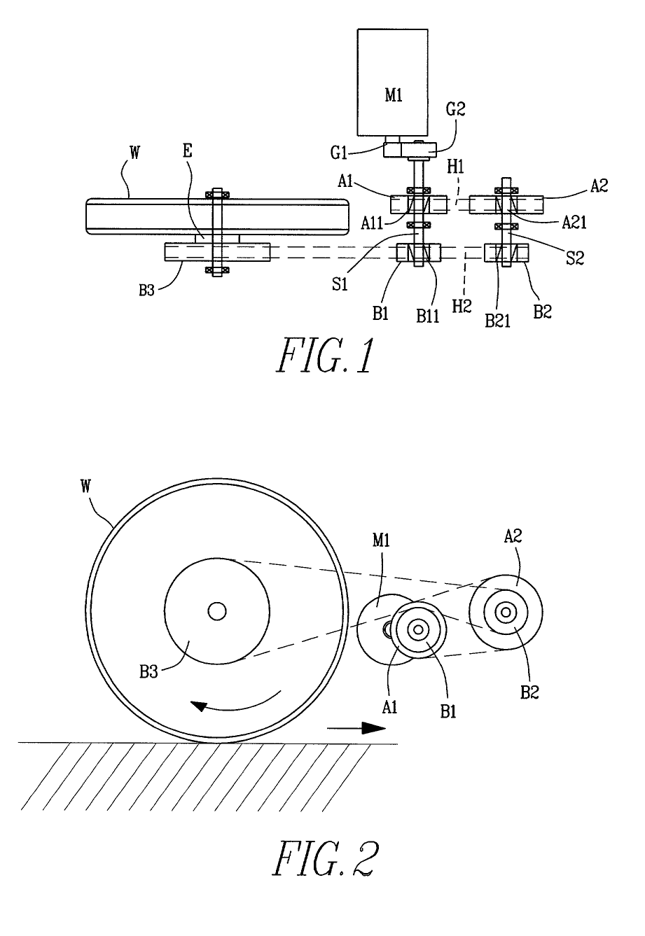

A first embodiment of a transmission system for an electric carrier in the present invention, as shown in FIGS. 1 and 2, includes a motor M1, two speed-reducing gears G1, G2, two transmitting shafts S1 (the first), S2 (the second), two pairs of chain wheels set A, B fixed on the two transmitting shafts S1, S2 respectively. The chain wheel set (A) contains a small chain wheel A1 and a big chain wheel A2 both having the same module, and a chain H1 extending around both the chain wheels A1 and A2. The small chain wheel A1 is fixed on the first transmitting shaft S1 by means of a one-way bearing A11. When the motor M1 is viewed from an output shaft, the shaft rotates the wheel clockwise, and the wheel rotates the shaft counterclockwise. The chain wheel set B contains two chain wheels B1, B2 of the same module and a big chain wheel B3 (a power output chain wheel) and a chain H2 extending around the three chain wheels B1, B2 and B3. The chain wheel B1 is located outside the chain H2, rotating in the reverse direction to the chain wheels B2 and B3. The chain wheel B1 is fixed on the first transmitting shaft S1 by means of a one-way bearing B11. The first transmitting shaft S1 can rotate counterclockwise against the chain wheel B1, and the chain wheel B1 can rotate clockwise against the shaft S1. The chain wheel B2 is fixed on the second transmitting shaft S2 by means of a one-way bearing B21. The second shaft S2 can rotate clockwise against the chain wheel B2, and the chain wheel B2 rotates counterclockwise against the second shaft S2. The power output chain wheel B3 is fixed on an axle, which the wheel of an electric carrier is fixed on.

The transmissible directions of the one-way bearings mentioned above are found in the table 1.

TABLE 1

| One-way | Shaft to the | The chain |
|---|---|---|
| bearing | chain wheel | wheel to Shaft |
| A11 | C | CC |
| A21 | CC | C |
| B11 | CC | C |
| B21 | C | CC |

“C” means clockwise. CC means counterclockwise.

The rotation method of the first embodiment of the transmission system is described below.

The first transmitting course of the first embodiment begins with the motor M1, which rotates clockwise the small speed-reducing gear G1, and then the big speed-reducing gear G2 together with the shaft S1 rotates counterclockwise. The small chain wheel A1 does not rotate with the first shaft S1 simultaneously owing to the one-way bearing A11. But the chain wheel B1 rotates counterclockwise, driving the chain H2 move clockwise, and the chain wheel B3 also rotates clockwise, driving the wheels (W) of an electric carrier run forward. The chain wheel B1 moves the chain H2 clockwise to transmit the chain wheel B2, but the second shaft S2 does not rotate together with the chain wheel B2 owing to the one-way bearing B21. Therefore, the first power-transmitting course does not move the second shaft H2, briefly shown as;

M1 (C)→G1 (C)→G2 (CC)→S1 (CC)→B1 (CC)→H2 (C)→B3 (C)

The reducing speed ratio is the total of the speed-reducing chain wheels G1, G2 and the speed-reducing chain wheels B1, B3, and the formula is shown as below.

(Tooth number of G2/Tooth number of G1)*(Tooth number of B3/Tooth number B1) [1]

This formula 1 is used to design the transmitting method for an electric carrier with high speed.

The second transmitting course begins with the motor 1, which rotates counterclockwise, transmitting through the second shaft 2, and shown briefly as below.

M1 (CC)→G1 (CC)→G2 (C)→S1 (C)→A1 (C)→H1 (C)→A2 (C)→S2 (C)→B2 (C)→H2 (C)→B3 (C).

The reducing gear ratio is the total of the speed-reducing gears S1, S2, the speed-reducing chain wheels A1, A2 and the reducing chain wheels B2, B3, so the formula is as below.

(Tooth number of G2/tooth number of G1)*(tooth number of A2/tooth number of A1)*(tooth number of B3/tooth number of B2) [2]

The second transmitting course has two reducing chain wheels A1, A2 (the tooth number A2>the tooth number of A1) more than the first transmitting course, and the tooth number of the chain wheel B2 is less than that of the chain wheel B1, so a larger speed-reducing ratio may be got, suitable for the transmission system for an electric carrier in case of needing high torque.

The first embodiment of the transmission system for an electric carrier only utilizes the motor M1 to rotate clockwise and counterclockwise, and the four one-way bearings for changing a kind of transmitting course to another kind or vice versa. When the electric carrier starts from a stationary condition, it needs a comparatively large torque output, so the second transmitting course may be preferably used to let the motor M1 rotate counterclockwise, permitting the transmitting system drive the wheels with a comparative large speed-reducing ratio to produce comparatively large torque for starting the electric carrier. After the electric carrier begins to move, and increases gradually its speed, the motor M1 rotates with high speed, and before it leaves the high peak of the best efficiency scope, a control system stops the motor M1 first, and then let it rotate clockwise, utilizing the first transmitting course with smaller speed-reducing ratio, letting the wheels run forward with comparatively high speed. In the same theory, when the electric carrier runs up a slope, it will slows down owing to insufficient torque, so the motor M1 is stopped before the electric carrier stops and changed to rotate counterclockwise to drive the carrier wheels with comparatively high speed-reducing ratio so as to conquer difficulty of running up a slope so that the electric carrier may run smoothly up the slope. The transmitting system for an electric carrier in the invention coordinates with an electric circuit control, detecting the output value and changing the motor to rotate clockwise or counterclockwise in due time within the best efficiency scope to cope with various road conditions and to obtain the goal of saving energy.

The transmitting system for an electric carrier in the invention has a clever structure, utilizing the four one-way bearings in cooperation of a motor rotating clockwise and counterclockwise, having two power transmitting courses for changing the speed of an electric carrier so that it is suitable for an electric carrier only moving forward and not backward, such as an electric motorcycle, an electric bike, an electric golf cart or an electric skate board.

In addition, When an electric carrier provided with the transmission system in the invention is moving up a slope and the motor suddenly stops, it may slide back down the slope because of the force of gravity, with the carrier wheels W and the chain wheel B3 rotating counterclockwise. Then the chain H2 pulls the chain wheels B1, B2 respectively clockwise and counterclockwise, and the first shaft S1 rotates clockwise and the second shaft S2 counterclockwise by means of the one-way bearings B11 and B21. And the chain wheel A1 rotates clockwise owing to the one-way bearing A11, but the chain wheel A2 rotates counterclockwise owing to the one-way bearing A21. Therefore, the chain wheel set (A) may produce self-locking because of different rotation of the chain wheels A1 and A2, impossible for the carrier wheels to rotate. Then the transmission system in the invention has a function of preventing an electric carrier from sliding backward in case of the motor stopping suddenly during running up a slope.

The transmission system in the invention has a self-locking function to prevent an electric carrier from sliding backward, but if a simple clutch E is fixed between the chain wheel B3 and the carrier wheel W, permitting the carrier wheel temporarily separated from the transmission system and possible to rotate freely, solving the problem of backward movement of the carrier wheels W.

In addition, two motors can be used as power source in the transmission system in the invention, in order to have five speed changing functions, which constitute a second embodiment of the invention.

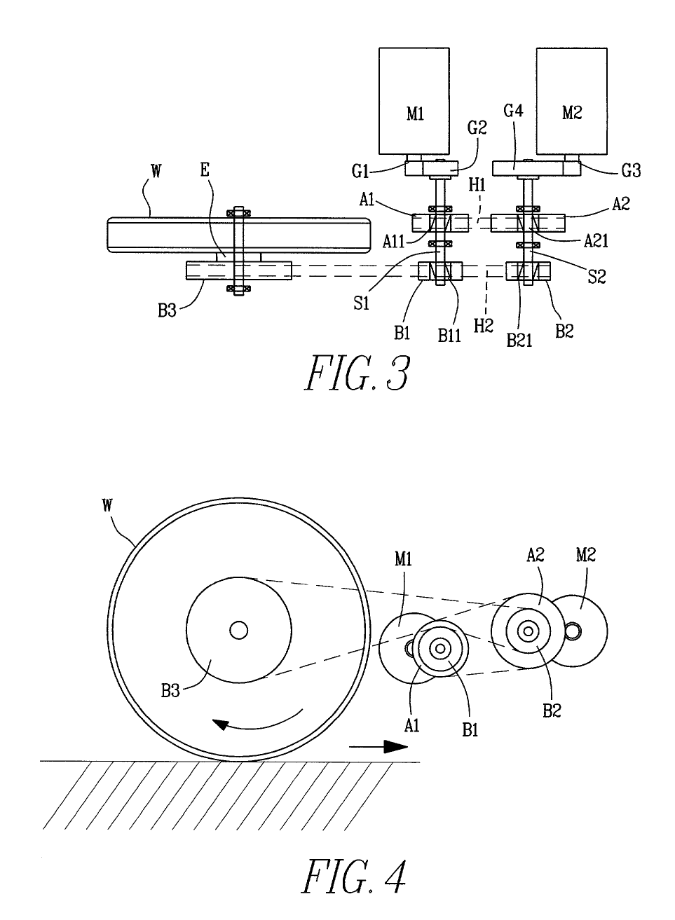

The second embodiment of a transmission system for an electric carrier in the invention, as shown in FIGS. 3 and 4, includes a first motor M1, a first pair of two speed-reducing gears G1 (the first one), G2 (the second one), a second motor M2, a second pair of speed-reducing gears G3 (the third one), G4 (the fourth one), and two parallel shafts S1 (the first one), S2 (the second one). combined together. The second speed-reducing gear G2 is fixed on the first shaft S1, and the fourth speed-reducing gear G4 is fixed on the second shaft S2. Further two transmitting chain wheel sets (A), (B) are provided to be fixed in a vertical condition on the first shaft S1 and the second shaft S2 respectively. The first chain wheel set (A) consists of a small chain wheel A1, a large chain wheel A2 and a chain H1 extending around both the chain wheels A1, A2. The small chain wheel A1 is fixed on the first shaft S1 by means of a one-way bearing A11, and the first shaft S1 can rotate clockwise, and the chain wheel A1 can rotate counterclockwise when viewed from the output shaft of the motor M1 in the direction of the motor M1. The large chain wheel A2 is fixed on the second shaft S2 by means of a one-way bearing A21, and the second shaft S2 rotates counterclockwise and the chain wheel A2 rotates clockwise. The chain wheel set (B) consists of a third chain wheel B1, a fourth chain wheel B2, a fifth power output chain wheel B3 and a chain H2 extending around the third, the fourth and the fifth chain wheels B1, B2 and B3, but the third chain wheel B1 is located outside the chain H2 to let the third chain wheel B1 rotates in a reverse direction to the fourth and the fifth chain wheel B2 and B3. The third chain wheel B1 is fixed on the first shaft S1 by means of a one-way bearing B11, and the first shaft S1 rotates clockwise, and the third chain wheel B1 rotates counterclockwise. The fourth chain wheel B2 is fixed on the second shaft S2 by mans of a one-way bearing B21, and the second shaft S2 rotates clockwise, but the fourth chain wheel B2 rotates counterclockwise. The fifth chain wheel B3 (the power output chain wheel) is fixed on an axle, which a carrier wheel is fixed on.

The transmitting direction of the one-way bearings A11, A21, B11 and B21 are shown in Table 2.

TABLE 2

| | Transmitting | Transmitting |
|---|---|---|
| One-way | direction (shaft | direction (wheel |
| bearing | to wheel) | to shaft) |
| A11 | C | CC |
| A21 | CC | C |
| B11 | CC | C |
| B21 | C | CC |

The second embodiment of the transmission system has the first and the second motors M1 and M2 rotate counterclockwise at the same time when viewed from the output shaft of the motor M1 to the first motor M1. When the first motor M1 rotates counterclockwise, the first small gear G1 rotates the second large gear G2 and the first shaft S1 clockwise owing to the first one-way bearing A11. So the first chain wheel A1 and the first shaft S1 rotate clockwise, and the third chain wheel B1 and the first shaft S1 rotates in the same direction. When the first chain wheel A1 rotates the second chain wheel A2 clockwise through the first chain H1, the second shaft S2 also rotates clockwise because of the second chain wheel A2 fixed with the one-way bearing B21. The fourth chain wheel B2 rotates also clockwise owing to the one-way bearing B21, with the chain H2 moving the fifth chain wheel B3 and the wheel W clockwise at the same time.

The transmitting course of the first motor M1 is shown as below.

M1 (CC)→G1 (CC)→G2 (C)→S1 (C)→A1 (C)→H1 (C)→A2 (C)→S2 (C)→B2 (C)→H2 (C)→B3 (C).

The speed-reducing ratio is the total of the speed-reducing gears G1, G2 and the speed reducing chain wheels A1, A2, B2 and B3, The formula is shown as below.

(Tooth number of G2/tooth number of G1)*(tooth number of A2/tooth number of A1)*(tooth number of B3/tooth number of B2). [3]

Next, the second motor M2 rotates the small gear G3 counterclockwise, and then the large gear G4 and second shaft S2 clockwise because of the one-way bearing A21, so the second chain wheel A2 does not rotate with the second shaft S2. The fourth chain wheel B2 rotates clockwise by means of the one-way bearing B21, moving the second chain H2 clockwise and the fifth chain wheel B3 also clockwise to drive the wheel W move forward. But the first shaft S1 does not rotate with the second shaft S2 owing to the one-way bearing B11. Therefore, the transmitting course of the second motor M2 does not pass through the second shat S2, and briefly shown as below.

M2 (CC)→G3(CC)→G4(C)→S2(C)→B2(C)→H2 (C)→B3(C).

The speed-reducing ratio is the total of the speed-reducing gears G3, 4 and the speed-reducing chain wheels B2, B3. The formula is as shown below.

(Tooth number of G4/tooth number of G3)*(tooth number of B3/tooth number of B2) [4]

Provided that the second motor 2 rotates counterclockwise with the speed n₂₁/minute, the wheel W and the fifth chain wheel B3 rotate clockwise with the speed n_{w2}/minute, and the relative formula of n_{w2} and n₂₁ is shown as below.

N_{w2}=n₂₁ {(tooth number of G4/tooth number of G3)*(tooth number of B3/tooth number of B2)} [5]

As the first and the second motors M1 and M2 at the same time rotate the wheels W to move an electric carrier, if the first motor M1 rotates counterclockwise at the speed n₁₁/minite, the wheels W and the fifth chain wheel B3 rotate clockwise at the speed n_{w1}/minute. As n_{w1=n}_{w2}, a formula is got as below.

N₁₁ {(tooth number of G2/tooth number of G1)*(tooth number of A2/tooth number of A1)*(tooth number of B3/tooth number of B2)}=n₂₁/{(tooth number of G4/tooth number of G3)*(tooth number of B3/tooth number of B2)} [6]

The formula 6 can be shortened as below.

N₁₁{(tooth number of G2/tooth number of G1)*(tooth number of A2/tooth number of A1)}=n₂₁/(tooth number of G4/toothnumber of G3) [7]

If the first and the second motor M1 and M2 have the same feature, a motor N11=a motor N21, so the next formula 8 can be got from the formula 7, shown below.

(Tooth number of G2/toothnumber of G1)*(tooth number of A2/tooth number of A1)=(tooth number of G4/tooth number of G3). [8]

If the transmission friction loss is not considered, the first and the second motor M1 and M2 have the same power, so the power of both the motors may merge together to a “plus” effect. Then the second embodiment of the transmission system has a function of power merger.

The formula 7 is the basis for designing in dividing the tooth number of the chain wheels used in the transmission system in the invention.

Next, the transmission system of the second embodiment has the two motors, so when the electric carrier uses a first stage (M1 and M2 rotating counterclockwise) to start from a stationary condition or to move on a slope, it begins to move forward slowly, or the slope is becoming less steep. At this time, the wheels needs less torque output, so this system makes use of a control system to cut off the first motor M1, letting the second motor M2 continue to rotate counterclockwise for producing a second stage of speed-changing effect, according to concept of saving electricity. Its transmitting course begins from the second motor M2 rotates the small gear G3 counterclockwise, and then the large gear G4 and the second shaft S2 clockwise owing to the one-way bearing A21. Then the second chain wheel A2 does not rotate with the second shaft S2. But the third chain wheel B2 rotates clockwise owing to the one-way bearing B21, moving the second chain H2 clockwise, and then also the fifth chain wheel B3 clockwise to move the wheels W forward. In spite that the fourth chain wheel B2 rotates indirectly the third chain wheel B1 though the second chain H2, the first shaft S1 does not rotate together owing to the one-way bearing B11. Thus, the transmitting course of the second motor M2 passes through the second shaft S2, briefly shown as below.

M2(CC)→G3(CC)→G4(C) S2(C0→B2(C)→H2(C)→B3(C).

The speed-reducing ratio is the total of the gears G3, G4 and the chain wheels B2, B3. Its formula is the same as the formula 4 mentioned above.

If a user wants to accelerate the electric carrier, the user keeps on the second motor M2 rotate counterclockwise and restart the first motor M1 from the static condition to rotate clockwise. Then the first motor M1 rotates the small gear G1 clockwise, then the large gear G2 and the first shaft S1 rotates counterclockwise, with the first chain wheel A1 does not rotates with the first shaft S1 owing to the one-way bearing A11. Further, the third chain wheel B1 rotates together with the first shaft S1 counterclockwise. And the second chain H2 moves the fifth chain wheel B3 clockwise because of the second chain H2 moves the outside of the third chain wheel B1. So the transmitting course is briefly shown as below.

M1(C)→G1(C)→G2(CC)→S1(CC)→B1(CC)→H2(C)→B3(C)

The speed-reducing ratio is the total of the first and the second gears G1, G2 plus the third and the fifth chain wheel B1 and B3. Its formula is shown below.

(Tooth number of G2/tooth number of G1)*(tooth number of B3/tooth number of BB1) [9]

At this time, the second motor M2 drives the wheel W with a high speed-reducing ratio, and the first motor M1 drives the wheel W forward with a low speed-reducing speed, so the transmission system enters the third stage of speed changing.

When the first motor M1 rotates with a comparatively low speed-reducing speed and merges with the second motor M2 in driving the electric carrier, the speed of the electric carrier becomes faster and faster. But if the second motor M2 stops its operation when the carrying weight diminishes and does not correspond to an efficient output, the first motor M2 will stop, letting only the first motor M1 continue to rotate clockwise, and the transmission system enters the fourth stage of speed changing, keeping on driving the wheels W forward. When the electric carrier is intended to move with far higher speed, the second motor M2 is started from the static condition, rotating clockwise, and then the transmitting course begins with the second motor M2 rotating clockwise and driving the small gear G3 also clockwise, and then the large gear G4 and the second shaft S2 counterclockwise owing to the one-way bearing A21, and so the second chain wheel A2 rotates with the second shaft S2 simultaneously. But the first chain H1 moves with the second chain wheel A2 counterclockwise, rotating the first chain wheel A1 also counterclockwise, and then the first shaft S1 also counterclockwise owing to the one-way bearing A11. Then the third chain wheel B1 is rotated by the first shaft S1 counterclockwise because of the one-way bearing B11. But the third chain wheel B1 is located outside the second chain H2, the third chain wheel B1 rotating counterclockwise drives the second chain H2 and the fifth chain wheel B3 and the carrier wheel W clockwise. So the transmitting course of the clockwise rotating second motor M2 is shown below.

M2(C)→G3(C)→G4(CC)→S2(CC)→A2(CC)→A1(CC)→S1(CC)→B1(CC)→H2(C)→B3(C)

The speed-reducing ratio is the total of the third and the fourth gear G3 and G4 plus the first and the second chain wheel A1 and A2 and the third and the fifth chain wheel B1 and B3. Its formula is shown below.

(Tooth number of G4/tooth number of G3)*(tooth number of A1/tooth number of A2)*(tooth number of B3/tooth number of B1) [10]

At the same time, the first motor M1 still rotates clockwise, driving the first small gear G1 clockwise and then the second large gear G2 and the first shaft S1 counterclockwise. Then the first chain wheel A1 does not rotate with the first shaft S1 simultaneously owing to the one-way bearing A11. In addition, the third chain wheel B1 rotates with the first shaft S1 counterclockwise owing to the one-way bearing B11. As the third chain wheel B1 is located outside the second chain H2, the second chain H2 moves the fifth chain wheel B3 and the wheel W clockwise. The transmitting course is briefly shown below.

M1(C)→G1(C)→G2(CC)→S1(CC)→B1(CC)→H2(C)→B3(C)

The speed-reducing ratio is the total of the first and the second gear G1 and G2 plus the third and the fifth chain wheel B1 and B3. Its formula is the same as the formula 9 mentioned above. At this time the power flow of the first and the second motor M1 and M2 are combined and merged together, moving through the first shaft S1, then to B1(CC)→H2(C)→B3(C), driving the carrier wheel W. This is the fifth stage of speed changing of the second embodiment.

Supposing that the load of the electric carrier is constant, the two motors of the second embodiment share the load in half respectively, with a comparatively low speed-reducing ratio to run fast so that the load of each motor is reduced half. So as for the characteristics of DC motors, the electric carrier may run faster with the same voltage.

The second embodiment of the transmission system for an electric carrier makes use of a simple electric circuit for controlling the two motors respectively rotating clockwise or counterclockwise, or stopping one of the motors, and using the four one-way bearings, achieving the five stages of speed alteration and power merging. Therefore, this system is much simpler than the conventional transmission system. The table 3 shows the relation between the rotating directions of the motors in the second embodiment.

TABLE 3

| | Rotating | Rotating | Applied |
|---|---|---|---|
| Stage | direction of M1 | direction of M2 | condition |
| 1 | CC | CC | Start or |
| | | | climbing a |
| | | | steep slope. |
| 2 | Stop | CC | Climbing a slow |
| | | | slope |
| 3 | C | CC | Switching time |
| | | | for high and |
| | | | low speed |
| 4 | C | Stop | Saving |
| | | | electricity for |
| | | | the load of “not |
| | | | fast speed |
| 5 | C | C | Fast speed or |
| | | | fast speed with |
| | | | a heavy load. |

In the transmission system of the second embodiment, when the electric carrier is located on an uphill, with the motors stopped and with the brake not operated, the electric carrier has a self-locking function to prevent it from sliding down. The reason is that when the gravity causes sliding backward, the fifth chain wheel B3 rotates counterclockwise, pulling the second chain H2 to rotate the third and the fourth chain wheel B1 and B2 respectively rotate clockwise and counterclockwise. Then the first shaft S1 rotates clockwise owing to the one-way bearing A11, but the second shaft S2 rotates counterclockwise. And the second chain wheel A2 rotates counterclockwise. As the first and the second shaft rotate in different direction, The first chain wheel set (A) produces self-locking, unable to rotate, so the transmission system in the invention has a function of preventing the carrier from sliding backward, even if is located on a uphill with the motors stopped.

The transmission system of the second embodiment has the self-locking function as the first embodiment, impossible to be moved back by manual force, but a simple clutch (E) can be installed on the axle of the fifth chain wheel B3 and the carrier wheel W, permitting the carrier wheel W separated temporarily from the transmission system to let the carrier wheel W rotate freely, solving the problem of backward movement.

As understood from the aforesaid description, the structural difference between the first and the second embodiment is additional provision of the second motor M2 and the third and fourth speed-reducing gears G3 and G4. It means that the first embodiment is more simple than the second one, so adding the second M2 and the third and the fourth speed-reducing gears G3 and G4 to the first embodiment can alter the first one into the second one, simplifying manufacturing procedures and reducing the number of components needed to be stored, resulting in more competitive force in market.

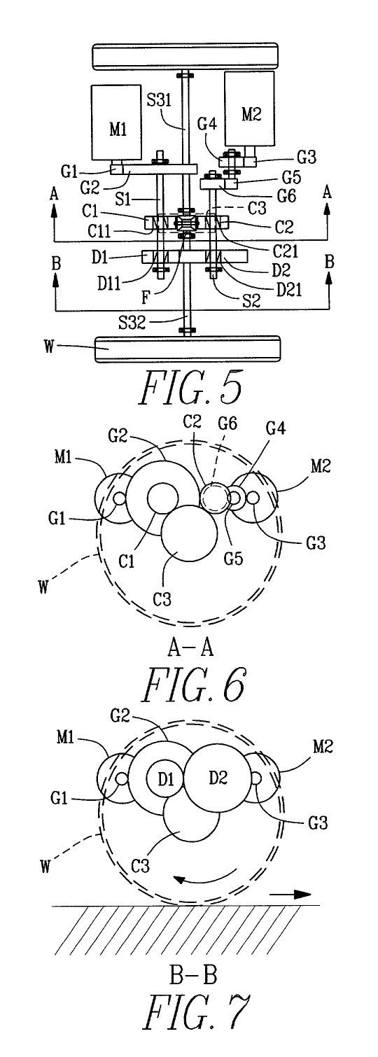

Next, a third embodiment of a transmission system in the invention is shown in FIGS. 5, 6 and 7, includes a first motor M1, a first speed-reducing gear G1 and a second speed-reducing gear G2 engaging with each other, a first shaft S1 with the second gear G2 fixed thereon, a second motor M2, two pairs of speed-reducing gears G3 (a third) G4 (a fourth); G5 (a fifth), G6 (a sixth) transmitting power to a second shaft S2, and two pairs of gears C, D fixed on the two shafts S1 and S2 in a vertical condition. The gear set (C) consists of a seventh gear C1 and a eighth gear C2 not engaging with each other, but an extra large gear C3 engages the first and the seventh and the eighth gear C1 and C2 and is fixed on an output shaft S3 in parallel with the first and the second shaft S1 and S2. The eighth gear C2 rotates counterclockwise to rotate the extra large gear C3 clockwise to drive the carrier wheel W forward. If the power shaft S3 is connected with a left and a right wheel W, a speed difference member F is fixed between the extra gear C3 and the power shaft S3. Then power course moves from the shafts S31 and S32 to the left and the right wheel. The seventh small gear C1 is fixed on the first shaft S1 by means of a one-way bearing C11 (the shaft S1 rotatable counterclockwise to the gear C1 and the gear C1 rotatable clockwise to the shaft when viewed from the output shaft of the first motor M1 to the motor M1). The eighth gear C2 is fixed on the second shaft S2 by means of a one-way bearing C21 (the shaft S2 rotatable counterclockwise to the extra gear C3 and the extra gear C3 rotatable clockwise to the shaft S2). The gear set (D) consists of a ninth gear D1 and a tenth gear D2 engaging with each other, with the ninth gear D1 has smaller teeth than those of the tenth gear D2. The ninth gear D1 is fixed on the first shaft S1 by means of a one-way bearing D21 (the shaft rotatable clockwise to the gear, and the gear rotatable counterclockwise to the shaft). The table 4 shows transmitting directions of the one-way bearings in the third embodiment.

TABLE 4

| | Transmissible | Transmissible |
|---|---|---|
| | direction of shaft | direction of gear |
| One-way bearing | to gear | to shaft |
| C11 | CC | C |
| C21 | CC | C |
| D11 | C | CC |
| D21 | C | CC |

According to the transmitting method of the third embodiment, the first motor M1 and the second motor M2 rotate counterclockwise at the same time, rotating the first small gear G1 counterclockwise, and then the second large gear G2 and the first shaft S1 clockwise, and the seventh gear C1 does not rotate with the first shaft S1 owing to the one-way bearing C1. The ninth gear D1 rotates with the first shaft S1 clockwise owing to the one-way bearing. The second shaft S2 rotates counterclockwise owing to the one-way bearing D21, and the eighth gear C2 with the second shaft S2 rotate counterclockwise and the extra large gear C3 clockwise to drive the carrier wheel W move forward.

The transmitting course is shown below.

M1(CC)→G1(CC)→G2(C)→S1(C)→D1(C)→D2(CC)→S2(CC)→C2(CC)→C3(C).

The speed-reducing ratio is the total of the first and the second gear G1 and G2 plus the ninth and the tenth gear D1, D2 and the eighth gear C2 and the extra large gear C3.

Its formula is shown below.

(Tooth number of G2/tooth number of G1)*(tooth number of D2/tooth number of D1)*(tooth number of C3/tooth number of C2) [11]

In addition, in the transmitting course of the second motor M2, the second motor M2 rotates counterclockwise, rotating the third small gear G3 counterclockwise and the fourth large gear G4 clockwise, and the fourth gear G4 and the fifth gear G5 rotate together on a same shaft, rotating the fifth gear G5 clockwise, and the sixth gear G6 rotates counterclockwise. Then the sixth gear G6 rotates the second shaft S2 counterclockwise owing to the one-way bearing C21, and so the eighth gear C2 with the second shaft rotates counterclockwise. Then the tenth gear D2 does not rotate with the second shaft S2. When the eighth gear C2 rotates counterclockwise, it rotates the extra large gear C3 and the power shaft S3 clockwise to drive the carrier wheel W forward.

The power-transmitting course of the second motor M2 is briefly shown below.

M2(CC)→G3(CC)→G4(C)→G5(C)→G6(CC)→S2(CC)→C2(CC)→C3(C)

The speed-reducing ratio is the total of the third and the fourth gear G3, G4 plus the fifth and the sixth gear G5, G6 and the eighth gear C2 and the extra large gear C3. Its formula is briefly shown below.

(tooth number of G4/tooth number of G3)*(toothy number of G6/tooth number of G5)*(tooth number of C3/tooth number of C2) [12]

Supposing that the second motor M2 rotates counterclockwise n₂₁/minute, the carrier wheels W and the extra gear C3 rotate n_{w2}/minute, and then the relative formula of n_{w2} and n₂₁ is shown below.

N_{w2}=n_{21/}{(tooth number of G4/tooth number of G3)*(tooth number of G6/tooth number of G5)*(tooth number of C3/tooth number of C2)} [13]

The first motor M1 and the second motor M2 drive the carrier wheels W to move the electric carrier forward. If the first motor M1 rotates counterclockwise n₁₁/minute, the carrier wheels W and the extra gear C3 rotate clockwise n_{w1}/minute, so n_{w1}=n_{w2}. Then a formula shown below may be induced.

N₁₁/{(tooth number of G2/tooth number of G1)*(tooth number of D2/tooth number D1)*(tooth number of C3/tooth number of C2)}=n₂₁/{(tooth number of G4/tooth number of G3)*(tooth number of G6/tooth number of G5)*(tooth number C3/tooth number C2)} [14]

The formula can be shortened as below.

N₁₁/{(tooth number of G2/tooth number of G1)*(tooth number of D2/tooth number of D1)*(tooth number of G4/tooth number of G3)*(tooth number of G6/tooth number of G5)} [15]

If the motors M1, M2 have the same feature, then n₁₁=n₂₁, and then a formula shown below is induced from the formula 15.

(Tooth number of G2/tooth number of G1)*(tooth number of D2/tooth number of D1)=tooth number of G4/tooth number of G3)*(tooth number of G6/tooth number of G5) [16]

The formula 16 is the basis for designing tooth dividing of the transmission system of the third embodiment.

Provided that the transmission friction loss is ignored, theoretically the two motors M1 and M2 can share the same horsepower, and in other words, the power of the first and the second motor M1 and M2 can have the effect of being added together. Thus, provision of the two motors in the third embodiment also has a function of merged power.

After the electrical carrier has the transmission system of the third embodiment using a front stage (M1 and M2 rotating counterclockwise) and stopped or climbed on a steep slope and then begun to move slowly or the slope became less steep, the carrier wheels needs less torque output. Then this system makes use of a control system to cut off the first motor M1, letting the second motor M2 continue to rotate counterclockwise, entering the second stage of speed-changing. The transmitting course of the second motor M2 is the same as the first stage mentioned above, the second motor M2 rotating counterclockwise to drive the third small gear G3 counterclockwise and the fourth large gear D4 clockwise, and the forth gear G4 and the fifth gear G5 rotate together on the same shaft. So the fifth gear G5 rotates clockwise to rotate the sixth gear G6 counterclockwise. Then the sixth gear G6 rotates the second shaft S2 counterclockwise owing to the one-way bearing C21. Thus the eighth gear C2 with the second shaft S2 rotates counterclockwise. The tenth gear D2 does not rotate with the second shaft S2 owing to the one-way bearing D21. When the eighth gear C2 rotates counterclockwise, the extra gear C3 and the second shaft S2 rotate clockwise to drive the carrier wheel W forward.

The transmitting course of the second motor M2 is as follows.

M2(CC)→G3(CC)→G4(C)→G5(C)→G6(CC)→S2(CC)→C2(CC)→C3(C).

The speed-reducing ratio is the total of the third and the fourth gear G3, G4 plus the fifth and the sixth gear G %, G6 and the eighth and the extra gear C2, C3. Its formula is the same as the formula 12 mentioned above.

If a user of the electric carrier wants to accelerate the speed, the user can permit the second motor M2 continue to rotate counterclockwise and start the first motor M1 from the static condition and rotate clockwise to enter the third stage of speed changing. Then the first motor M1 has the transmitting course of the first motor M1 rotating the first small gear G1 clockwise, and then the second large gear G2 and the first shaft S1 counterclockwise, and the extra gear C3 and the power shaft S3 rotate together clockwise to drive the carrier wheel W forward. Then the ninth gear D1 does not rotate with the first shaft S1 owing to the one-way bearing D1. Although the seventh gear C1 transmits the eighth gear C2 via the extra gear C3, the second shaft S2 does not rotate owing to the one-way bearing C21 provided between the eighth gear 2 and the second shaft S2. Therefore, the transmitting course of the first motor M1 does not pass through the second shaft S2. The transmitting course is briefly shown below.

M1(C)→G1(C)→G2(CC)→S1(CC)→C1(CC)→C3(C)→S3(C)

The speed-reducing ratio is the total of the first and the second gear G1, G2 plus the seventh and the extra gear C1 and C3. Its formula is shown below.

(Tooth number of G2/tooth number of G1)*(tooth number of C3/tooth number of C1) [18]

Then the third stage of speed changing is performed by the second motor M2 driving the carrier wheel W with comparatively high speed-reducing ratio, and by the first motor M1 driving the carrier wheel with comparatively low speed-reducing ratio.

When the first motor M1 merges driving with comparatively low speed-reducing ratio, the speed becomes faster and faster, and when the second motor M2 has its load light, not conforming to the efficient output, the second motor M2 may stop, leaving only the first motor M1 keeps on rotating clockwise, entering the fourth stage of speed-changing to keep the carrier wheels move forward.

Under the fourth stage of speed-changing, the first motor M1 still rotates clockwise, driving the first small gear G1 clockwise, and the second large gear G2 and the first shaft S1 counterclockwise, and the seventh gear C1 and the first shaft S1 rotate counterclockwise together owing to the one-way bearing C1. Then the extra gear C3 and the power shaft S3 rotate clockwise to drive the carrier wheel W forward. The ninth gear D1 does not rotate together with the second shaft S2 owing to the one-way bearing D11. Although the seventh gear C1 rotates the eighth gear C2 via the extra gear C3, the eighth gear and the first shaft S1 does not rotate together. Thus, the transmitting course of the first motor M1 does not pass through the second shaft S2. Its transmitting course is briefly shown below.

M1(C)→G1(C)→G2(CC)→S1(CC)→C1(CC)→C3(C)→S3(C)

Its speed-reducing ratio is the total of the first and the second gear G1, G2 plus the seventh and the extra gear C1 and C3. Its formula is the same as the formula 18 mentioned above.

If the electric carrier is needed to run forward with higher speed, the first motor M1 still rotates clockwise, and the second motor M2 may be started from the static condition clockwise and enter the fifth stage of speed changing. Then the transmitting course of the second motor M2 begins with the second motor M2 rotating the third small gear G3 and the fourth large gear G4 counterclockwise, and then the fifth gear G5 rotating counterclockwise to drive the sixth gear G6 clockwise. Then the sixth gear G6 rotates the second shaft S2 clockwise owing to the one-way bearing C21, so the second gear C2 does not rotate with the second shaft S2 together. Further the tenth gear D2 rotates with the second shaft S2 clockwise, driving the ninth gear counterclockwise, and the first shaft S1 also rotates counterclockwise owing to the one-way bearing D11, causing the seventh gear C1 rotate also counterclockwise to drive the carrier wheel W rotate clockwise to run forward.

Then the transmitting course of the second motor M2 is briefly shown below.

M2(C)→G3(C)→G4(CC)→G5(CC)→G6(C)→S2(C)→D2(C)→D1(CC)→S1(CC)→C1(CC)→C3(C).

The speed-reducing ratio is the total of the third gear G3, the fourth gear G4, the fifth gear G5, the sixth gear G6, the ninth gear D1, the tenth gear D2, the seventh gear C1 and the extra gear C3, and its formula is the same as the formula 17 mentioned above,

At this time under the fifth stage of speed changing, the two motors M1, M2 have power transmitted together through the first shaft 1 and the seventh gear C1 to the extra gear C3 to drive the carrier wheel W move forward. So assuming that the load of the electric carrier is invariable, the two motor M1, M2 are preferably rotated to let the carrier run fast with comparatively low speed-reducing ratio, and then the load can be divided on the two motors, with each motor having only half the load. As for the feature of DC motors, the speed is surly fast under the same voltage with the load reduced.

As understood from the aforesaid description, the transmission system of the third embodiment operates the two motors to rotate clockwise or counterclockwise with a simple electric circuit, or stopping one of the two motors with functions of the four one-way bearings, achieving the effect of five stages of speed changing and merged power. So the third embodiment, as the same as the second embodiment, has a simpler structure than the conventional transmission system. In order to make the five stages of speed changing, Table 5 shows the relative condition between the rotating directions of the motors and the speed changing.

TABLE 5

| | Rotating | Rotating | Applicable |
|---|---|---|---|
| Stage | direction of M1 | direction of M2 | condition |
| 1 | CC | CC | Start or |
| | | | climbing up a |
| | | | slope |
| 2 | Stop | CC | Climbing slow |
| | | | slope |
| 3 | C | C | Switching time |
| | | | for high and low |
| | | | speed. |
| 4 | C | Stop | Saving |
| | | | electricity for |
| | | | the load of “not |
| | | | fast speed” |
| 5 | C | C | Fast speed with |
| | | | or without a |
| | | | heave load |

The transmission system by means of gears in the third embodiment has a function of self-locking, so when the electric carrier is located on an uphill with the motors stopped and with the brake not operated, it still may not slide down the uphill. The reason is that when the wheels W produce sliding down force owing to the gravity, with the extra gear C3 rotating counterclockwise, rotating the seventh and the eighth gear C1, C2 clockwise, the first and the second shaft S1 and S2 rotate clockwise owing to the two one-way bearings C11, C21. So the ninth gear D1 rotates clockwise, and the tenth gear D2 also rotates clockwise owing to the one-way bearings D21. As the ninth and the tenth gear D1, D2 rotate in the same direction and engage each other. The gear set D produces self locking, impossible to rotate. Therefore, the electric carrier is prevented from sliding backward, in spite of it located on an uphill.

Like the first and the second embodiment, the third embodiment of a transmission system can also be provided with a simple clutch between the place where the carrier wheel W is fixed with the output shaft S31 or S32 for separating the carrier wheel W from the same shaft S31 or S32 to let the carrier wheel rotatable freely to retreat back, in spite of the self locking of the transmission system.

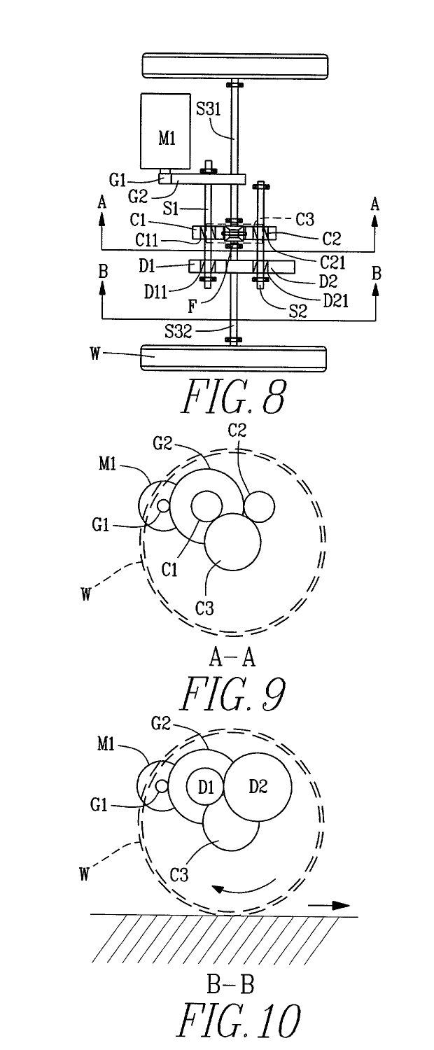

Furthermore, the transmission system in the third embodiment can be altered to that using one motor in the first embodiment, by removing the second motor M2, the third, the fourth, the fifth and the sixth gear G3, G4, G5 and G6, becoming a fourth embodiment of a transmission system in the invention, as shown in FIGS. 8, 9 and 10. When the electric carrier is set to a comparatively low stage, not needing high transmitting output or comparatively many stages of speed changing, the fourth embodiment can be used, by removing the components mentioned just above in the third embodiment, having two stages of speed changing, simplifying the structure of the transmission system to be more competitive in market.

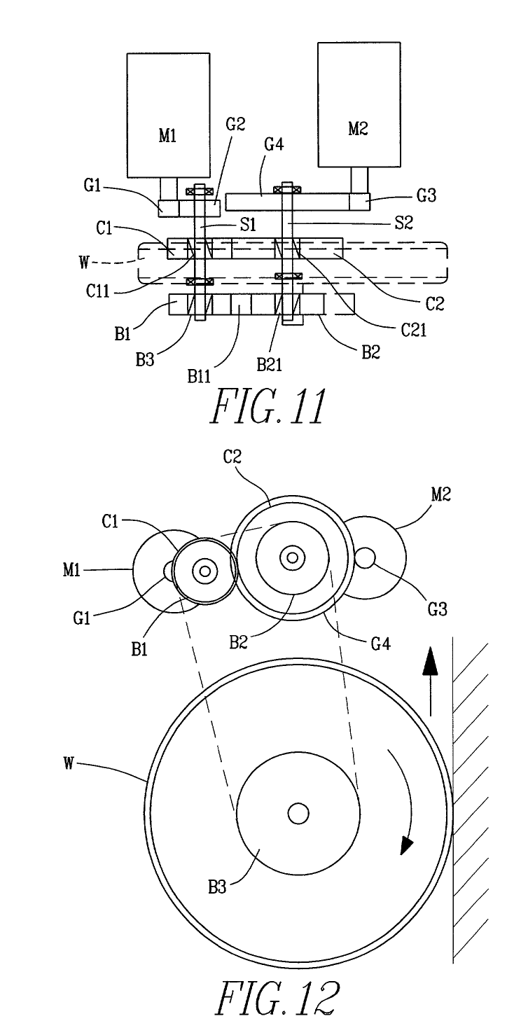

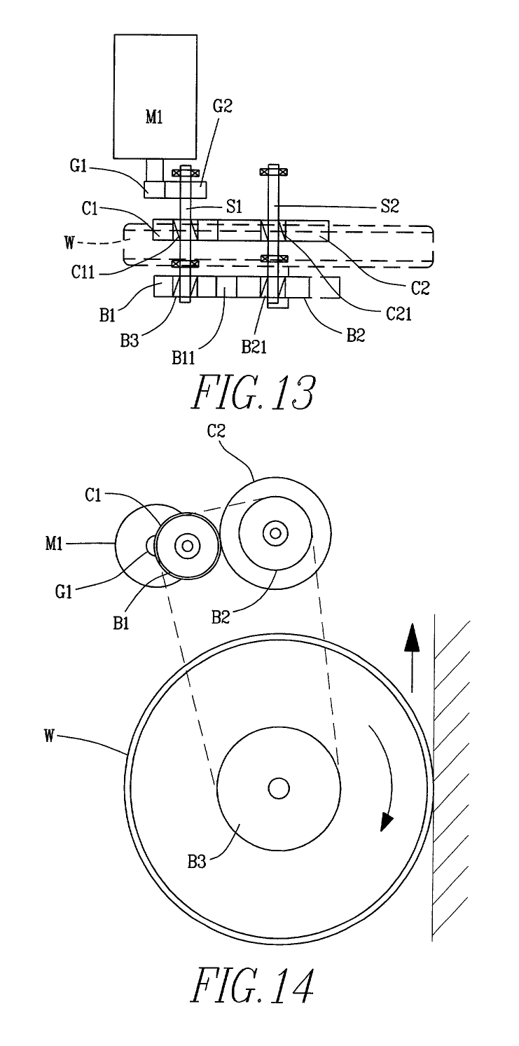

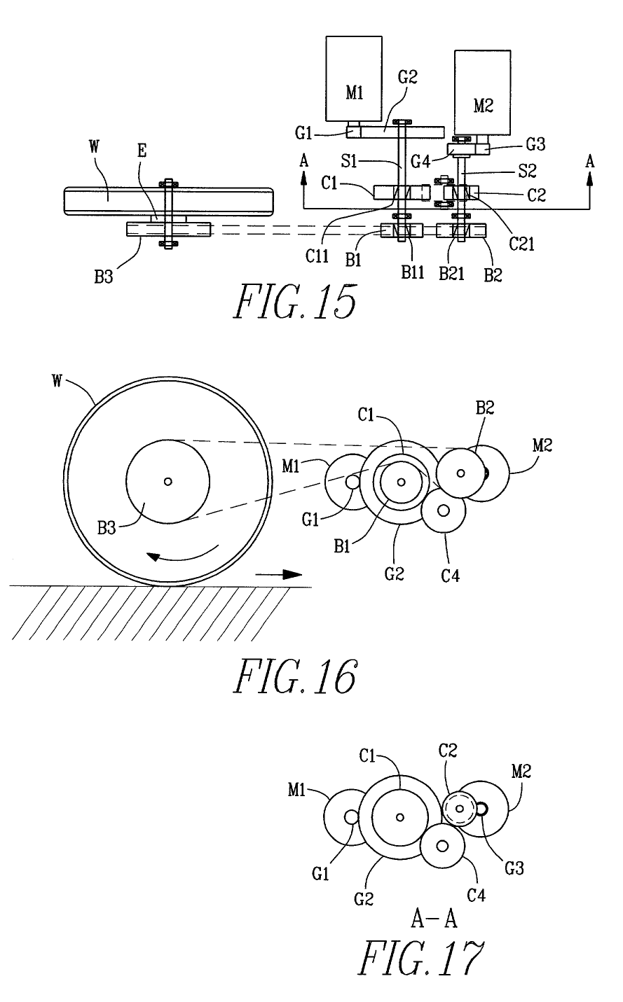

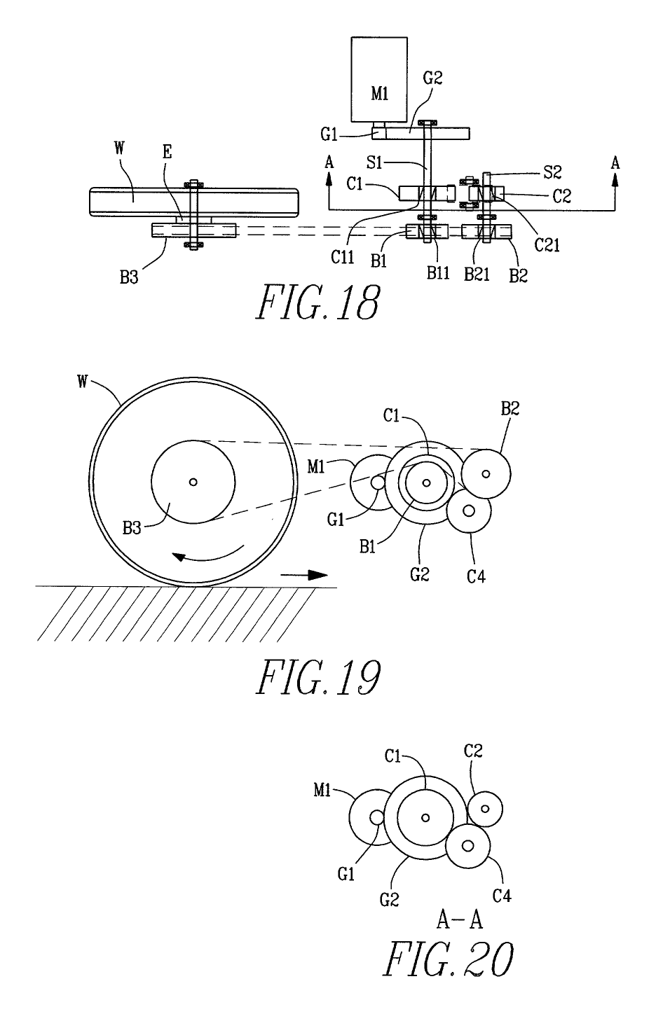

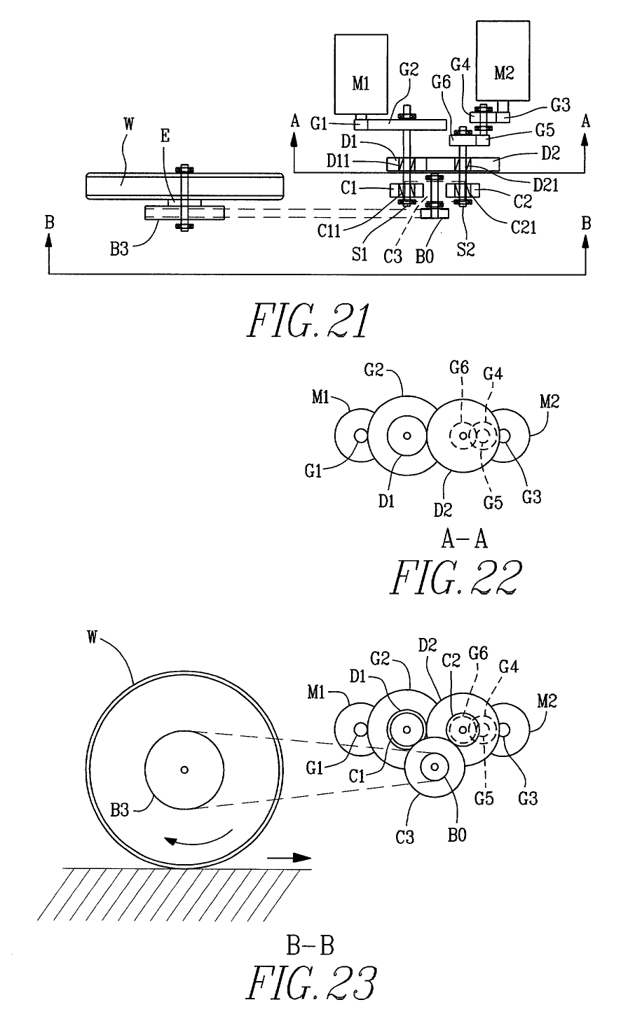

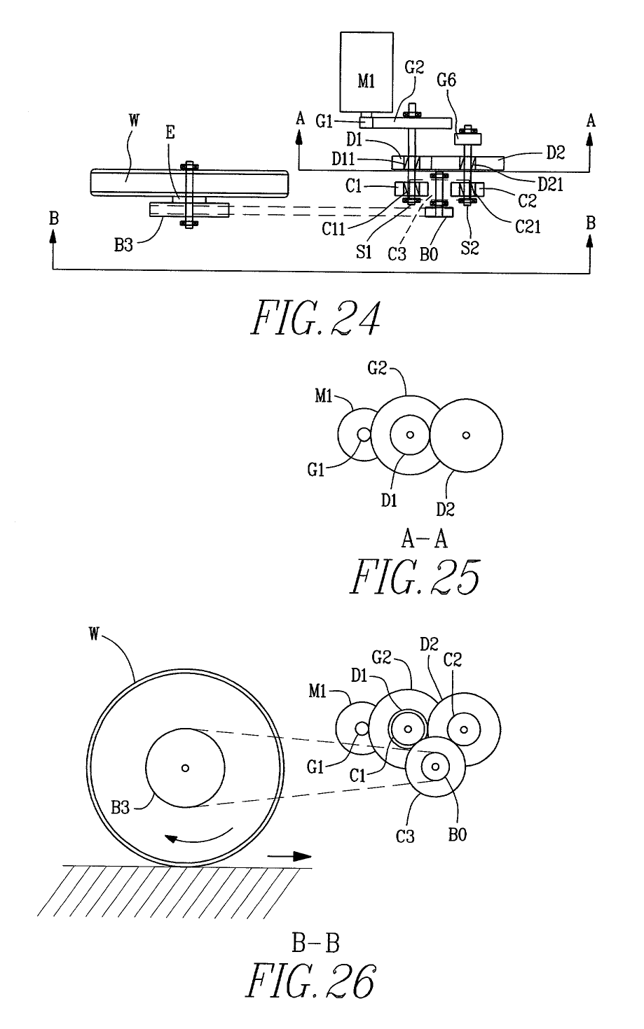

In general, the four kinds of embodiments of a transmission system in the invention have the common characteristics that they all have two parallel transmitting shafts, two transmitting gears fixed vertical on the transmitting shafts, a plurality of one-way bearings combined between each gear and the shaft, and one of the transmitting gear set fixed on an output axle to drive the carrier wheel rotate to run forward. And one or two motors are provided, depending on practical necessity. The whole system controls clockwise or counterclockwise rotation of the motor(s) or stopping the motor(s) with cooperation of the one-way bearings to change the transmitting course and merging power. Besides, belts and belt wheels can be used instead of the chains and the chain wheels to induce a fifth, a sixth, a seventh, an eighth, a ninth and a tenth embodiment of the invention as shown in FIGS. 11-26. Table 6 shows the features of the transmission systems of those embodiments

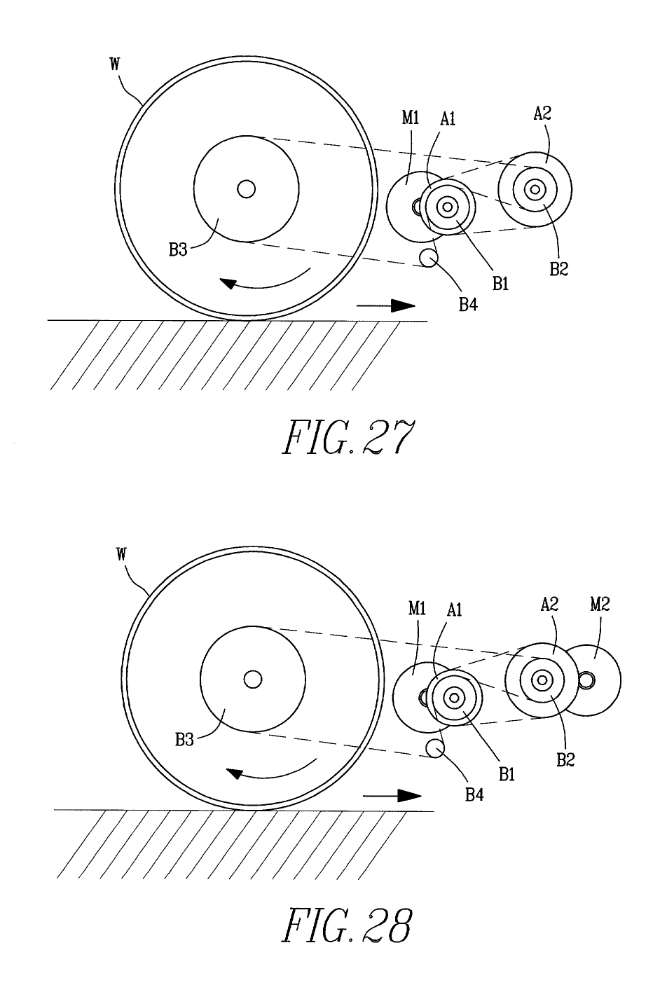

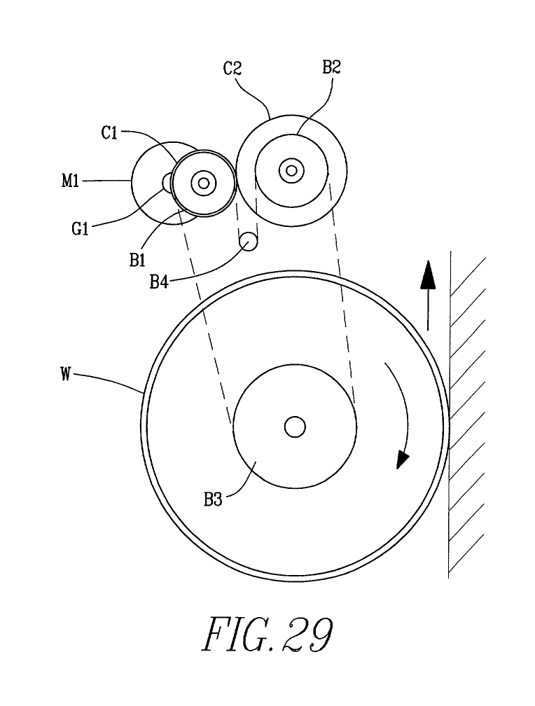

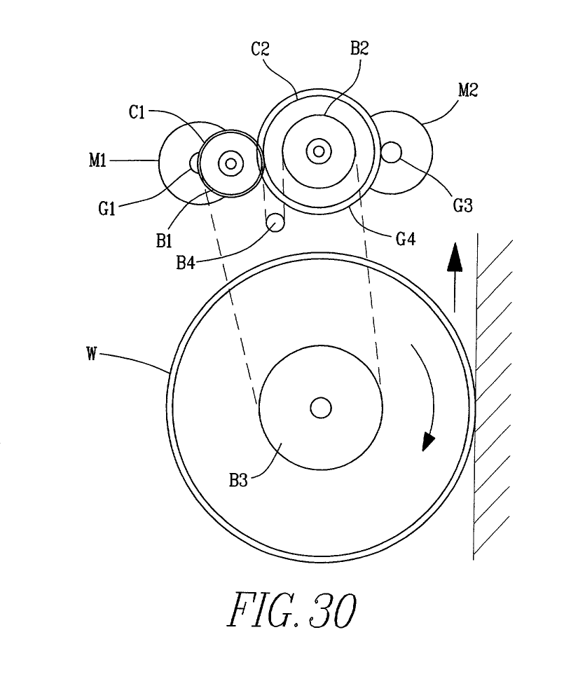

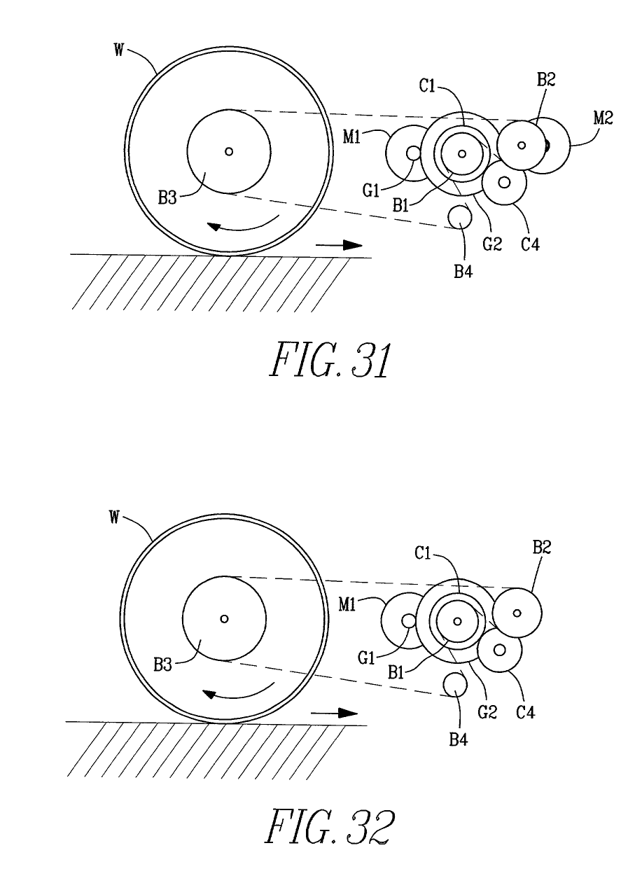

In the first, the second, the fifth, the sixth, the seventh and the eighth embodiment, the transmission system is composed of a plurality of chain wheels and a plurality of chains. In order to increase surrounding angles between each chain wheel and each chain, an idle wheel (also a chain wheel) B4 may be installed between the chain wheel B1 and B3 or the chain wheel B1 and B2, as shown in FIGS. 27-32, increasing transmitting stability between the chain wheels and the chains in the eleventh, the twelfth, the thirteenth, the fourteenth, the fifteenth, the sixteenth embodiments. The idle wheel B4 may be fixed on an outer surface or in the transmission system case, or on a proper position of a frame of the electric carrier.

While the preferred embodiments of the invention have been described above, it will be recognized and understood that various modifications may be made therein and the appended claims are intended to cover all such modifications that may fall within the spirit and scope of the invention

TABLE 6

| | Motor | | | | | | | |
|---|---|---|---|---|---|---|---|---|
| Type | number | First transmitting set | | Second transmitting set | | Output unit | Stage | Figures |
| 1 | 1 | Chain wheel A1 | Chain wheel A2 | Chain wheel B1 | Chain wheel B2 | Chain wheel B3 | 2 | 1, 2 |
| | | Having a one-way | Having a one-way | Having a one-way | Having a one-way | | | |
| | | bearing to let A1 | bearing to let | bearing to let | bearing to let | | | |
| | | rotate C. | A2 rotate CC. | B1 rotate CC. | B2 rotate C. | | | |
| 2 | 2 | Chain wheel A1 | Chain wheel A2 | Chain wheel B1 | Chain wheel B2 | Chain wheel B3 | 5 | 3, 4 |
| | | Having one-way | Having a one-way | Having one-way | Having a one-way | | | |
| | | bearing to let A1 | bearing to let | bearing to let | bearing to let | | | |
| | | rotate C. | A2 rotate CC. | B1 rotate CC. | B2 rotate C. | | | |
| 3 | 2 | Gear C1 | Gear C2 | Gear D1 | Gear D2 | Gear C3 | 5 | 5, 6, 7 |
| | | Having a one-way | Having a one-way | Having a one-way | Having a one-way | | | |
| | | bearing to let C1 | bearing to let | bearing to let | bearing to let | | | |
| | | rotate CC. | C2 rotate CC. | D1 rotate C. | D2 rotate C. | | | |
| 4 | 1 | Gear C1 | Gear C2 | Gear D1 | Gear D2 | Gear C3 | 2 | 8, 9, 10 |
| | | Having a one-way | Having a one-way | Having a one-way | Having a one-way | | | |
| | | bearing to let C1 | bearing to let | bearing to let | bearing to let | | | |
| | | rotate CC. | C2 to rotate CC. | D1 rotate C. | D2 rotate C. | | | |
| 5 | 2 | Belt wheel | Belt wheel | Chain wheeB1 | Vhain wheel B2 | Chain wheel B3 | 5 | 1, 2 |
| | | Having a one-way | Having a one-way | Having a one-way | Having a one-way | | | |
| | | bearing to let belt | bearing to let belt | bearing to let | bearing to let | | | |
| | | wheel to rotate C. | belt wheel to | B1 rotate CC. | B2 rotate C. | | | |
| | | | rotate CC. | | | | | |
| 6 | 1 | Belt wheel | Belt wheel | Chain wheel B1 | Chain wheel B2 | Chain wheel B3 | 2 | 3, 4 |
| | | Having a one-way | Having a one-way | Having a one-way | Having a one-way | | | |
| | | bearing to let belt | bearing to let | bearing to let | bearing to let | | | |
| | | wheel to rotate C. | belt wheel to | B1 rotate CC. | B2 rotate C. | | | |
| | | | rotate CC. | | | | | |
| 7 | 2 | Gear 1 | Gear 2 | Chain wheel B1 | Chain wheel B2 | Chain wheel B3 | 5 | 11, 12 |
| | | Having a one-way | Having a one-way | Having a one-way | Having a one-way | | | |
| | | bearing to let | bearing to let belt | bearing to let | bearing to let | | | |
| | | belt wheel to | wheel to | B1 rotate C. | B2 rotate C. | | | |
| | | rotate CC. | rotate CC. | | | | | |
| 8 | 1 | Gear C1 | Gear C2 | Chain wheel B1 | Chain wheel B2 | Chain wheel B3 | 2 | 13, 14 |
| | | Having a one-way | Having a one-way | Having a one-way | Having a one-way | | | |
| | | bearing to let | bearing to let | bearing to let | bearing to let | | | |
| | | belt wheel to | belt wheel to | B1 rotate C. | B2 rotate C. | | | |
| | | rotate CC. | rotate CC. | | | | | |

| | | | | | | | | | | |
|---|---|---|---|---|---|---|---|---|---|---|
| 9 | 2 | Gear C1 | Gear C2 | Idle wheel | Chain | Chain | | | | |
| | | | | | wheel B1 | wheel B2 | Idle wheel | Chain wheel B3 | 5 | 15, 16, 17 |
| | | Having a | Having a | C4 | Having a | Having a | C4 | | | |
| | | one-way | one-way | | one-way | one-way | | | | |
| | | bearing | bearing | | bearing | bearing | | | | |
| | | to let belt | to let belt | | to let B1 | to let B2 | | | | |
| | | wheel to | wheel to | | rotate CC. | rotate C. | | | | |
| | | rotate C. | rotate CC. | | | | | | | |
| 10 | 1 | Gear C1 | Gear C2 | Idle wheel C | Chain | Chain | | | | |
| | | | | | wheel B1 | wheel B2 | Idle wheel C | Chain wheel B3 | 2 | 18, 19, 20 |
| | | Having a | Having a | | Having a | Having a | | | | |
| | | one-way | one-way | | one-way | one-way | | | | |
| | | bearing | bearing | | bearing | bearing | | | | |
| | | to let C1 | to let belt | | to let B1 | to let B2 | | | | |
| | | rotate C. | wheel to | | rotate CC. | rotate C. | | | | |
| | | | rotate CC. | | | | | | | |

| | | | | | | | | |
|---|---|---|---|---|---|---|---|---|
| 11 | 2 | Gear C1 | Gear C2 | Chain wheel D1 | Chain wheel D2 | Gear C3 + Chain wheel | 5 | 21, 22, 23 |
| | | Having a one-way | Having a one-way | Having a one-way | Having a one-way | B0 + Chain wheel B3. | | |
| | | bearing to let | bearing to let | bearing to let | bearing to let | | | |
| | | belt wheel to | belt wheel to | D1 rotate C. | D2 rotate C. | | | |
| | | rotate CC. | rotate CC. | | | | | |
| 12 | 1 | Gear C1 | Gear C2 | Chain wheel D1 | Chain wheel D2 | Gear C3 + Chain | 2 | 24, 25, 26 |
| | | Having a one-way | Having a one-way | Having a one-way | Having a one-way | wheel B0 + Chain | | |
| | | bearing to let | bearing to let | bearing to let | bearing to let | wheel B3 | | |
| | | belt wheel to | belt wheel to | D1 rotate C. | D2 rotate C. | | | |
| | | rotate CC. | rotate CC. | | | | | |

I claim:

1. A transmission system for an electric carrier comprising:
A power source;
Two parallel transmitting shafts rotated by said power source, a transmitting gear set fixed respectively on each said transmitting shaft in a vertical position;
A one-way bearing combined between each said transmitting gear and said transmitting shaft; and,
A power output chain wheel fixed on a same axle, which a carrier wheel is fixed on to be rotated to move forward;
Said power source possible to rotate clockwise or counterclockwise, said one-way bearings and said rotation of said power source cooperating with each other for changing a transmitting course to change the speed of said electric carrier, and characterized by manufacturing cost reduced, operation simplified and effect of saving energy.

2. The transmission system for an electric carrier as claimed in claim 1, wherein said power source is only one motor, having two stages of speed changing by means of clockwise and counterclockwise rotation of said motor.

3. The transmission system for an electric carrier as claimed in claim 1, wherein said power source is two motors possible to rotate clockwise and counterclockwise, and five stages of speed changing and merging the power of said two motors are achieved by the clockwise and counterclockwise rotation of said two motors and with one of said motors stoppable.

4. The transmission system for an electric carrier as claimed in claim 1, wherein said transmission system has a self locking function in case of said electric carrier is located on an uphill with said motor(s) stopped.

5. The transmission system for an electric carrier as claimed in claim 1, wherein said transmitting means consists of at least two transmitting elements.

6. The transmission system for an electric carrier as claimed in claim 1, wherein said transmitting means consists of a plurality of chain wheels and two chains

7. The transmission system for an electric carrier as claimed in claim 1, wherein said transmitting means consists of a plurality of belt wheels and two belts.

8. The transmission system for an electric carrier as claimed in claim 1, wherein said transmitting means consists of a plurality of gears.

9. The transmitting system for an electric carrier as claimed in claim 1 wherein a clutch is provided between said output wheel and said carrier wheel.

10. The transmitting system for an electric carrier as claimed in claim 1, wherein a speed differing means is provided between said two parallel shafts.
